(19) United States
(12) Patent Application Publication
(10) Pub. No.: US 2006/0102236 A1
(43) Pub. Date: May 18, 2006

(54) Integrated pressure regulator and pressure gauge

(76) Inventors: Alan Phillips, Jackson, TN (US); Daniel Paxton Wall, Humbolt, TN (US)

Correspondence Address: THE BLACK & DECKER CORPORATION, 701 EAST JOPPA ROAD, TW199, TOWSON, MD, 21286, US

(21) Appl. No.: 10/856,413

(22) Filed: May 28, 2004

Related U.S. Application Data
(60) Provisional application No. 60/473,721, filed on May 28, 2003.

(51) Int. Cl. F16K 37/00

(52) U.S. Cl. 137/557

(57) ABSTRACT

An integrated pressure regulator and pressure gauge employs a pressure gauge in a biasing assembly, e.g. integrated into a knob. The integrated pressure regulator and pressure gauge includes an adapter body; a plunger which forms a seal to retain a regulated pressure and includes a bleed off passageway, a tap into the regulated pressure, and a post including an O-ring seal; a knob threadably connected to the adapter body; a spring compressed between the knob and the plunger; and a pressure gauge connected to the post.

### CROSS-REFERENCE TO RELATED APPLICATIONS

The present application claims the benefit under 35 U.S.C. § 119(e) of U.S. Provisional Application Ser. No. 60/473,721, filed May 28, 2003. Said U.S. Provisional Application Ser. No. 60/473,721 is herein incorporated by reference in its entirety.

### FIELD OF THE INVENTION

The present invention generally relates to the field of pneumatics, and more particularly to an integrated pressure regulator and pressure gauge.

### BACKGROUND OF THE INVENTION

A pressure regulator is supplied with a fluid (such as air) at an intake port and expels the fluid through an exhaust port at a differing pressure. Pressure regulators typically include an additional port for connecting a pressure gauge to measure the pressure of fluid expelled from the pressure regulator.

Referring to FIGS. 1 and 2, a pressure regulator 100 includes an adapter body 102 having an intake port 104 and an exhaust port 106, for connecting coupling devices, pipes, pressure hoses, tubes, and the like. A plunger 108 forms a seal to retain a regulated pressure 110 and includes a bleed off port 112. A biasing assembly such as a knob 120 is threadably connected to the adapter body. A spring 122 is compressed between the knob and the plunger. Typically, a port 124 is included for connecting an external pressure gauge 126. The plunger abutting the spring is affixed to a pressure control valve 109 abutting a small (i.e. in relation to spring 122) spring 123. The pressure control valve connected between the spring 122 (via the plunger) and the small spring 123 maintains the regulated pressure in proportion to the rotational position of the knob.

Because the pressure regulator 100 includes the additional port for connecting the external pressure gauge, the size, weight, cost, and manufacturing complexity of the pressure regulator may be high. The pressure regulator 100 may also be cumbersome in the field. For example, the external pressure gauge protruding from the pressure regulator may become entangled with pressure hoses and tubes being used in the vicinity. Further, if the pressure regulator 100 and the pressure gauge 126 are recessed within a casing or assembly, it may prove difficult to position them for viewing the pressure gauge while simultaneously operating the pressure regulator. For instance, a pressure regulator and an external pressure gauge recessed within an assembly of pressure hoses, tubes, and/or pipes may provide limited access for adjusting the pressure gauge and prevent viewing the pressure regulator simultaneously.

Thus, it would be desirable to provide a pressure regulator having an integrated pressure gauge.

### SUMMARY OF THE INVENTION

Accordingly, the present invention is directed to an integrated pressure regulator and pressure gauge, such as a pressure regulator employing a pressure gauge in a biasing assembly, e.g. integrated into a knob. For example, an integrated pressure regulator and pressure gauge includes an adapter body for connecting coupling devices, pipes, pressure hoses, and/or tubes; a plunger which forms a seal to retain a regulated pressure and includes a bleed off passageway, a tap into the regulated pressure, and a post including an o-ring seal; a biasing assembly such as the knob; a spring compressed between the knob and the plunger; and a pressure gauge connected to the post. The plunger abutting the spring is affixed to a pressure control valve, such as a valve abutting a small spring, for maintaining the regulated pressure in proportion to the rotational position of the knob.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an end elevational view of a prior art pressure regulator assembly including an external pressure gauge and an additional port therefor;

FIG. 2 is a partial cross-sectional side elevational view of the pressure regulator assembly shown in FIG. 1;

FIG. 3 is a front view of an integrated pressure regulator and pressure gauge in accordance with an exemplary embodiment of the present invention, wherein the pressure regulator is connected with coupling hardware;

FIG. 4 is an isometric view of the integrated pressure regulator and pressure gauge illustrated in FIG. 3;

FIG. 5 is an end elevational view of an integrated pressure regulator and pressure gauge, employing a pressure gauge in the knob of a pressure regulator assembly in accordance with an exemplary embodiment of the present invention; and

FIG. 6 is a partial cross-sectional side elevational view of the integrated pressure regulator and pressure gauge illustrated in FIG. 5.

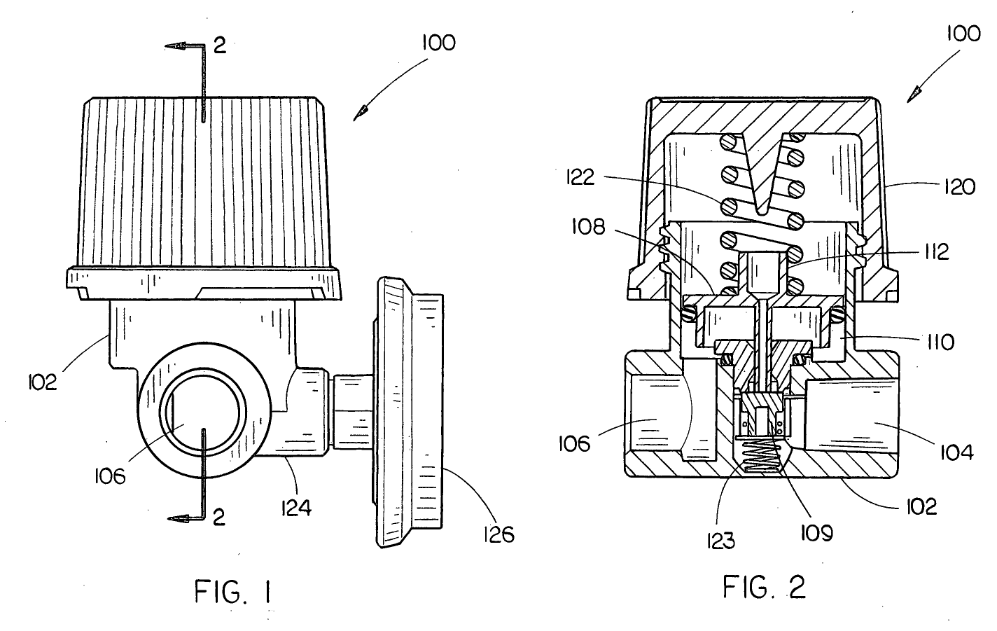

### DETAILED DESCRIPTION OF THE INVENTION

Reference will now be made in detail to the presently preferred embodiments of the invention, examples of which are illustrated in the accompanying drawings.

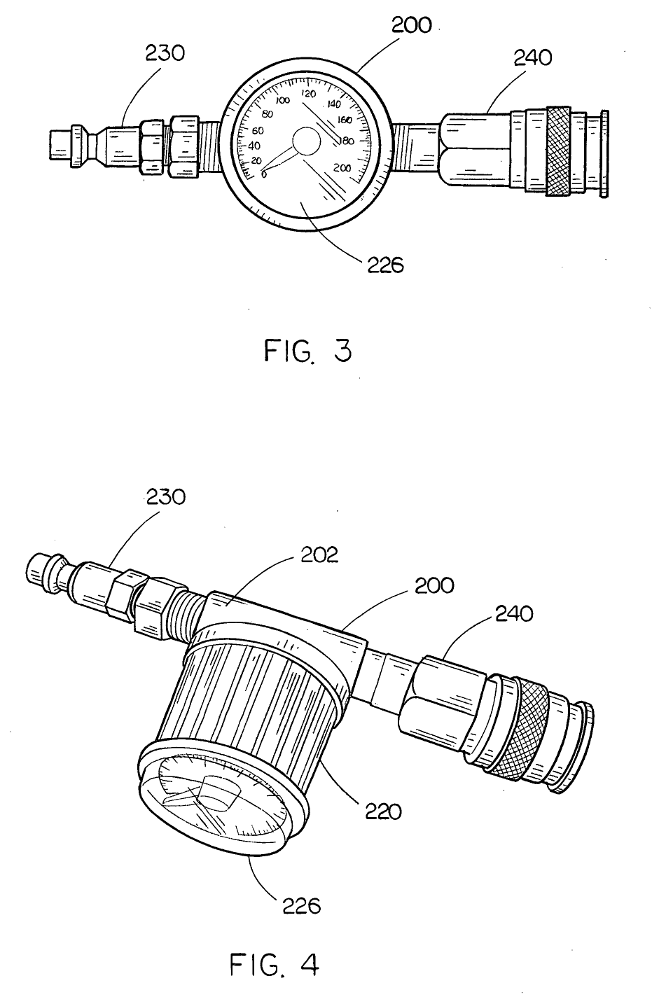

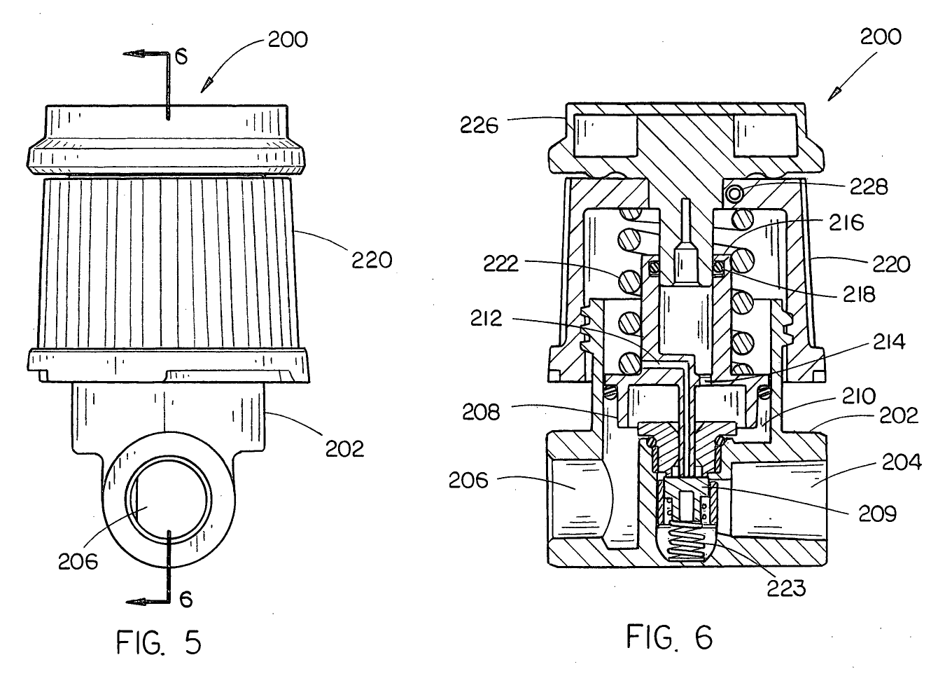

Referring to FIGS. 3 through 6, an integrated pressure regulator and pressure gauge 200 is described. In embodiments, the pressure regulator 200 includes an adapter body 202, a biasing assembly such as a knob 220, and a pressure gauge 226 integrated into the pressure regulator, e.g. integrated into the knob. For example, the pressure gauge may be positioned coaxially within the knob. The integrated pressure regulator and pressure gauge 200 may connect to a variety of coupling devices, pipes, pressure hoses, tubes, and the like 230 and 240, (e.g. pneumatic-type quick connects). Alternatively, the pressure regulator 200 may be integrated into an assembly such as an air compressor, an air tool, or the like.

The adapter body 202 includes an intake port 204 and an exhaust port 206, for connecting the coupling devices, pipes, pressure hoses, tubes, and the like. For instance, the intake port may be connected to a pressurized fluid supply, such as an air compressor, while the exhaust port may be connected to an air tool, such as an air-powered nail gun, or the like. A plunger 208 forms a seal to retain a regulated pressure 210 and includes a bleed off passageway 212, a tap 214 into the regulated pressure, and a post 216 including an O-ring seal 218. The knob 220 is threadably connected to the adapter body 202. A spring 222 is compressed between the knob and the plunger.

The pressure gauge 226 is slidably inserted into the post and connected to the knob with a roll pin 228 or the like. In embodiments, the gauge and the knob are positioned coaxially. The post may be shaped for preventing rotational movement of the pressure gauge (with respect to the post), such as hex-shaped. Alternatively, a pin or the like may be included for preventing rotation of the gauge with respect to the post. The plunger abutting the spring is affixed to a pressure control valve, such as a valve 209 abutting a small (i.e. in relation to spring 222) spring 223.

The valve connected between the spring 222 (via the plunger) and the small spring 223 maintains the regulated pressure in proportion to the rotational position of the knob. For example, the valve 209 may have an input connected to the intake port 204 and an output connected to the exhaust port 206, such as for regulating pressurized air supplied to the nail gun by the air compressor. While the pressure control valve in a present embodiment includes the valve 209 connected between the spring 222 and the small spring 223, it is understood that a variety of other pressure control valves may be utilized without departing from the scope of the present invention.

In another embodiment, the pressure gauge 226 is fixedly connected to the post 216, such as at a pre-selected height equal to or exceeding a maximum range of the knob 220. Alternatively, the pressure gauge 226 and the knob 220 may be provided as an integrated assembly for ease of manufacturing and/or assembly. This may be desirable for allowing the pressure gauge to remain rotationally stationary (i.e. with respect to the adapter body) while the knob is adjusted. In still further embodiments, the pressure gauge is recessed below the knob, such as for protecting the gauge.

The integrated pressure regulator and pressure gauge 200 may have attendant advantages over typical pressure regulators and external pressure gauges. Because it does not require a separate external port for connecting a pressure gauge, the size, weight, cost, and manufacturing complexity of the integrated pressure regulator and pressure gauge 200 may be significantly reduced. The pressure regulator 200 may also be much less cumbersome in the field, not having a pressure gauge protruding from an external port. Further, if the pressure regulator 200 is recessed within a casing or assembly, an operator may more easily view the pressure gauge 226 while simultaneously operating the pressure regulator, such as for enabling the operator to more quickly adjust the pressure regulator to a desired pressure.

It should be noted that fluid pressure seen by the pressure gauge 226 may be seen over a portion of the plunger 208. This pressure may act with the spring 222, requiring either of a lower spring rate and hence a smaller and lighter spring, or a lower stressed spring. Also, faster and more accurate recovery of pressure when a tool is attached to the pressure regulator 200 may result.

In exemplary embodiments, the pressure gauge 226 includes an analog display. However, those of skill in the art will appreciate that the pressure gauge may also include a digital display. Alternatively, the pressure gauge may not have a display; it may be an electronic device used to measure a fluid pressure and subsequently transmit a fluid pressure reading to a remote location. In embodiments, the pressure gauge 226 may include a liquid filled gauge, a diaphragm seal gauge, a spiral gauge, a digital gauge, a vacuum gauge, an absolute pressure gauge, and/or a differential gauge. Other gauges may also be utilized with the pressure regulator 200.

While the mechanism for biasing the pressure control valve as described in this exemplary embodiment is the knob 220, those of skill in the art will appreciate that a variety of other mechanisms may be contemplated. For instance, the pressure gauge 226 may be integrated into a crank, a handle, and the like, these mechanisms being threadably attached to the adapter body 202 in the same manner as the knob. The pressure gauge may also be integrated into a pressure regulator having a lever for biasing the pressure control valve, the lever being pivotally attached to the adapter body for compressing the spring 222. Further, the pressure regulator need not include a biasing mechanism at all. For instance, a pressure regulator for retaining a constant pressure may utilize an integrated pressure gauge.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A pressure regulator, comprising:
a pressure control valve having an input and an output for controlling pressurized fluid delivery, the input for coupling with a pressurized fluid supply; and
a pressure gauge coupled with the output of the pressure control valve for measuring a regulated fluid pressure,
wherein the pressure gauge is integrated into the pressure regulator.

2. The pressure regulator of claim 1, further comprising an adapter body having an intake port coupled with the input of the pressure control valve and an exhaust port coupled with the output of the pressure control valve.

3. The pressure regulator of claim 1, further comprising a plunger having a tap connected between the pressure control valve and the pressure gauge for supplying the regulated fluid pressure to the pressure gauge.

4. The pressure regulator of claim 3, wherein the plunger includes a bleed off passageway for limiting the regulated fluid pressure.

5. The pressure regulator of claim 3, wherein the plunger includes a post having a seal, slidably connected to the pressure gauge for supplying the regulated fluid pressure to the pressure gauge.

6. A pressure regulator, comprising:
a pressure control valve having an input and an output for controlling pressurized fluid delivery, the input for coupling with a pressurized fluid supply;
a pressure gauge coupled with the output of the pressure control valve for measuring a regulated fluid pressure;
a plunger having a tap connected between the pressure control valve and the pressure gauge for supplying the regulated fluid pressure to the pressure gauge; and
a biasing assembly connected to the pressure control valve via the plunger for controlling the regulated fluid pressure,
wherein the pressure gauge is integrated into the biasing assembly.

7. The pressure regulator of claim 6, wherein the pressure gauge is included in the biasing assembly for measurement of the regulated fluid pressure controlled by the biasing assembly.

8. The pressure regulator of claim 6, wherein the biasing assembly includes a knob threadably connected to the adapter body and having a spring compressed between the knob and the plunger, configured to bias the pressure control valve.

9. The pressure regulator of claim 6, wherein the biasing assembly includes a crank threadably connected to the adapter body and having a spring compressed between the crank and the plunger, configured to bias the pressure control valve.

10. The pressure regulator of claim 6, wherein the biasing assembly includes a handle threadably connected to the adapter body and having a spring compressed between the handle and the plunger, configured to bias the pressure control valve.

11. The pressure regulator of claim 6, wherein the biasing assembly includes a lever pivotally connected to the adapter body and having a spring compressed between the lever and the plunger, configured to bias the pressure control valve.

12. The pressure regulator of claim 6, further comprising a pin connected between the pressure gauge and the biasing assembly for connecting the pressure gauge to the biasing assembly.

13. A pressure regulator, comprising:
a pressure control valve having an input and an output for controlling pressurized fluid delivery, the input for coupling with a pressurized fluid supply;
a pressure gauge coupled with the output of the pressure control valve for measuring a regulated fluid pressure;
an adapter body having an intake port coupled with the input of the pressure control valve and an exhaust port coupled with the output of the pressure control valve;
a plunger having a tap connected between the pressure control valve and the pressure gauge for supplying the regulated fluid pressure to the pressure gauge, including a bleed off passageway for limiting the regulated fluid pressure and a post having a seal, slidably connected to the pressure gauge for supplying the regulated fluid pressure to the pressure gauge;
a biasing assembly disposed of the pressure control valve via the plunger for controlling the regulated fluid pressure, including a knob threadably connected to the adapter body and having a spring compressed between the knob and the plunger, configured to bias the pressure control valve; and
a pin connected between the pressure gauge and the biasing assembly for connecting the pressure gauge to the biasing assembly,
wherein the pressure gauge is integrated into the biasing assembly for measurement of the regulated fluid pressure controlled by the biasing assembly.

14. The pressure regulator of claim 13, wherein the knob includes a crank.

15. The pressure regulator of claim 13, wherein the knob includes a handle.

16. The pressure regulator of claim 13, wherein the knob threadably connected to the adapter body includes a lever pivotally connected to the adapter body.

17. A pressure regulator, comprising:
means for controlling pressurized fluid delivery coupled with a pressurized fluid supply; and
means for measuring a regulated fluid pressure coupled with the means for controlling pressurized fluid delivery,
wherein the measuring means is integrated into the controlling means.

18. The pressure regulator of claim 17, further comprising means for supplying the regulated fluid pressure to the measuring means.

19. The pressure regulator of claim 18, wherein the supplying means includes means for limiting the regulated fluid pressure.

20. The pressure regulator of claim 18, further comprising a biasing means connected to the controlling means via the supplying means, for controlling the regulated fluid pressure.

21. The pressure regulator of claim 20, wherein the measuring means is integrated into the biasing means for measurement of the regulated fluid pressure controlled by the biasing means.

22. The pressure regulator of claim 20, further comprising a connecting means between the measuring means and the biasing means, for connecting the measuring means to the biasing means.

23. A pressure regulator, comprising:
a pressure control valve having an input and an output for controlling pressurized fluid delivery, the input for coupling with a pressurized fluid supply;
a pressure gauge coupled with the output of the pressure control valve for measuring a regulated fluid pressure;
a plunger having a tap connected between the pressure control valve and the pressure gauge for supplying the regulated fluid pressure to the pressure gauge; and
a biasing assembly coaxially positioned with the pressure gauge and connected to the pressure control valve via the plunger for controlling the regulated fluid pressure,
wherein the pressure gauge is integrated into the biasing assembly.

24. The pressure regulator of claim 23, wherein the pressure gauge is included in the biasing assembly for measurement of the regulated fluid pressure controlled by the biasing assembly.

25. The pressure regulator of claim 23, wherein the biasing assembly includes a knob threadably connected to the adapter body and having a spring compressed between the knob and the plunger, configured to bias the pressure control valve.

26. The pressure regulator of claim 23, wherein the biasing assembly includes a crank threadably connected to the adapter body and having a spring compressed between the crank and the plunger, configured to bias the pressure control valve.

27. The pressure regulator of claim 23, wherein the biasing assembly includes a handle threadably connected to the adapter body and having a spring compressed between the handle and the plunger, configured to bias the pressure control valve.

28. The pressure regulator of claim 23, wherein the biasing assembly includes a lever pivotally connected to the adapter body and having a spring compressed between the lever and the plunger, configured to bias the pressure control valve.

29. The pressure regulator of claim 23, further comprising a pin connected between the pressure gauge and the biasing assembly for connecting the pressure gauge to the biasing assembly.
